(19) United States
(12) Patent Application Publication
(10) Pub. No.: US 2009/0084279 A1
(43) Pub. Date: Apr. 2, 2009

(54) RELIEF PRINTING PLATE AND PRINTED MATTER

(75) Inventors: Hironori Kawakami, Tokyo (JP); Koji Takeshita, Tokyo (JP); Takahisa Shimizu, Tokyo (JP); Nahoko Inokuchi, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 11/864,691

(22) Filed: Sep. 28, 2007

(51) Int. Cl. B41N 1/12

(52) U.S. Cl. 101/395

(57) ABSTRACT

A relief printing plate has a convex part, wherein a top surface of the convex part, which touches a substrate, comprises a resin layer having an affinity for an ink liquid including an organic light emitting material and the convex part or a convex part forming layer including the convex part, which supports the resin layer, comprises an ink repellent layer which has non-affinity for the ink.

### BACKGROUND OF THE INVENTION

1. Field of the Invention

The present invention relates to a relief printing plate used for printing that uses an ink material to form a pattern on a substrate for precision components such as an organic electroluminescence (EL) element and relates to a printed matter formed by using the relief printing plate.

2. Description of the Related Art

An organic EL element emits light when a current is supplied to a light emitting layer which is formed from an organic light emitting material and between two opposed electrodes. In order to achieve efficient light emission, it is important to keep a film thickness of the light emitting layer to about 100 nm. Further, in the case of forming a display from the organic EL element, it is necessary to perform patterning on the organic EL element with high definition.

As the organic light emitting material for the light emitting layer formed on a substrate or the like, a low molecular material and a high molecular material are usable. The low molecular material is subjected to resistive heating vapor deposition and the like to form a thin film, and at the same time the patterning is performed by using a microscopically patterned mask. However, this method has a problem that patterning accuracy is reduced with an increase in the size of a substrate.

Therefore, the high molecular material has recently been used as the organic light emitting material, and a method of forming a thin film by wet coating with a coating liquid obtained by dispersing or dissolving the organic light emitting material into a solvent has been tried.

As the wet coating method for the thin film formation, spin coating, bar coating, projection coating, dip coating, and the like are known. However, the wet coating methods have difficulty in realizing high definition patterning and color coding with R, G, and B, and it is considered that the thin film is most effectively formed by a printing process that is capable of achieving excellent color coding and patterning.

It is often that an organic electroluminescence element or a display uses a glass substrate as a substrate. Thus, a method that uses a metal hard printing plate such as a gravure printing method is unsuitable. Offset printing that uses a rubber blanket having elasticity and a relief printing method that uses a rubber printing plate and photosensitive resin printing plate having elasticity are suitable. As an attempt to use these printing methods, a method (Japanese Patent Laid-Open No. 2001-93668 Official Gazette) by offset printing and a method (Japanese Patent Laid-Open No. 2001-155858 Official Gazette) by relief printing are really proposed.

It is known that there is a most suitable viscosity in an ink of a viscous type (in other word, thixotropy type) or a liquid type used for printing or coating in various printing methods such as the relief printing method, intaglio printing method and offset printing method. Especially, a viscosity modifier such as a thickener is generally added to a liquid type ink.

On the other hand, when a film is formed by printing an organic light emitting material using a printing method, an organic light emitting material is dispersed or dissolved in a solvent such as a water, an alcohol or an organic solvent (including a binder resin if necessary), thereby an ink for printing or coating is made.

However, as for general organic light emitting materials which can be an ink, even if solubility for a solvent is high, max content of solid based on a solvent is about 5%. If a content of solid is beyond the max content, an organic light emitting material separates out as solid, therefore it is difficult to make an ink of high viscosity.

Especially, in a case where a pattern of a film of an organic light emitting material is formed and the pattern is made to emit light in an element, the higher the purity of a film made of an organic light emitting material is, the better the durability of an element is. Therefore, since the remained thickener or the like lower the purity, the thickener or the like can not be included in an ink. Therefore, for this reason, it is also difficult to make an organic light emitting ink of high viscosity.

As a result, in a case where an ink of an organic light emitting material is printed by relief printing, since an ink has low viscosity, an ink which is put on a top surface of a convex part of a relief printing plate flows to a lower part or a concave part, corresponding to non-printing area, of a relief printing plate, and remains there. Therefore reproducibility in printing a pattern of a film of an organic light emitting material is bad and the film thickness of a pattern of a film becomes uneven. Therefore, it is difficult to obtain good repeatability in the manufacturing of a printed matter.

[patent document 1] JP-A-2001-93668

[patent document 2] JP-A-2001-155858

[patent document 3] JP-A-2001-155861

### SUMMARY OF THE INVENTION

An object of the present invention is to solve a problem of low repeatability in printing when an ink having low viscosity is printed using a relief printing plate. One embodiment of the present invention is a relief printing plate having a convex part, wherein a top surface of the convex part, which touches a substrate, comprises a resin layer having an affinity for an ink liquid including an organic light emitting material and wherein the rest of the convex part or a convex part forming layer including the convex part, which supports the resin layer, comprises an ink repellent layer which has non-affinity for the ink.

### BRIEF DESCRIPTION OF THE DRAWINGS

FIG. 1 is a transverse cross-sectional view of a relief printing plate of an embodiment of the present invention.

FIG. 2 (a) is a transverse cross-sectional view showing one example of a manufacturing process of a laminate material in the manufacturing of a relief printing plate of one embodiment of the present invention.

FIG. 2 (b) is a transverse cross-sectional view showing another example of a manufacturing process of a laminate material in the manufacturing of a relief printing plate of one embodiment of the present invention.

FIG. 3 (a) is a transverse cross-sectional view showing one example of a manufacturing process of a laminate material in the manufacturing of a relief printing plate of one embodiment of the present invention.

FIG. 3 (b) is a transverse cross-sectional view showing another example of a manufacturing process of a laminate material in the manufacturing of a relief printing plate of one embodiment of the present invention.

FIG. 4 (a) is a transverse cross-sectional view showing one example of a manufacturing process of a laminate material in the manufacturing of a relief printing plate of one embodiment of the present invention.

FIG. 4 (b) is a transverse cross-sectional view showing another example of a manufacturing process of a laminate material in the manufacturing of a relief printing plate of one embodiment of the present invention.

FIG. 5 (a) is a transverse cross-sectional view showing one example of a manufacturing process of a laminate material in the manufacturing of a relief printing plate of one embodiment of the present invention.

FIG. 5 (b) is a transverse cross-sectional view showing another example of a manufacturing process of a laminate material in the manufacturing of a relief printing plate of one embodiment of the present invention.

FIG. 6 is a transverse cross-sectional view showing one example of a manufacturing process of a laminate material in the manufacturing of a relief printing plate of one embodiment of the present invention.

FIG. 7 is a side view showing one embodiment of a relief printing machine using a relief printing plate of one embodiment of the present invention.

In these drawings, S is a relief printing plate; S0 is a laminate material; each of S1 and S2 is a laminated body; 1A is a convex part; 1A0 is a concave part; 1B is a top surface; 1 is a base material; 2 is an adhesive; 3 is an adhesive; 4 is a protective base material; 5 is an easily peeling agent; and 6 is an adhesive.

### DESCRIPTION OF THE PREFERRED EMBODIMENTS

Hereinafter, one embodiment of the present invention is described with reference to the figures. However, the present invention is not limited to the described embodiment.

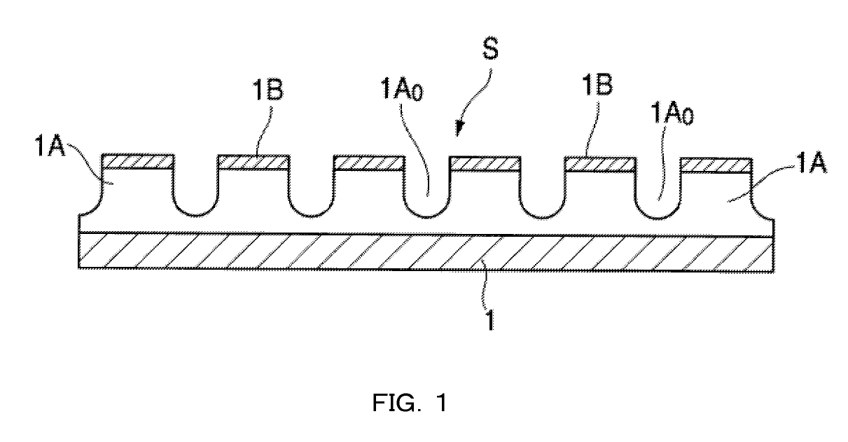

FIG. 1 is a transverse cross-sectional view of a relief printing plate S for manufacturing an organic electroluminescence element in one embodiment of the present invention. Reference numeral 1 designates a base material layer of a relief printing plate. Reference numeral 1A designates a convex part or a convex part forming layer including the convex part on the base material layer (Hereinafter these members are simply called a convex part.). Convex part 1A is an ink repellent layer having non-affinity (repellent property) for an ink including an organic light emitting material. In addition, reference numeral 1B is a top surface of the convex part. Top surface 1B is a resin layer having affinity for an ink including an organic light emitting material.

Convex part 1A comprises a material having a repellent property for an ink which is used. It is desirable that one or more kinds of following materials should be selected: fluorine system polymers such as a resin material including an additive having molecular frame with a fluorine atom, fluorine system elastomer, polytetrafluoroethylene, polyvinylidene fluoride, poly 6 vinylidene fluoride and copolymer thereof. In addition, convex part 1A does not have to be comprised of a material which is different from a material constitutes top surface 1B. For example, materials comprised of a material including fluorine and a material without fluorine, wherein the ratios of a material including fluorine to a material without fluorine are different from each other, can be used for convex part 1A and top surface 1B.

Top surface 1B should have affinity for an ink to be used. Rubbers such as butadiene acrylonitrile rubber, silicone rubber, isoprene rubber, styrene-butadiene rubber, butadiene rubber, chloroprene rubber, isobutylene-isoprene rubber, acrylonitrile rubber, ethylene propylene rubber and urethane rubber, synthetic resins such as polyethylen, polystyrene, polybutadiene, polyvinyl chloride, polyvinylidene chloride, polyvinyl acetate, polyamide, polyethersulfone, polyethylene terephthalate, polyethylenenaphthalate, polyethersulfone, polyvinyl alcohol and copolymer thereof, and natural polymers such as cellulose can be used for top surface 1B.

Especially, it is desirable that a material including a water-soluble polymer as a main component should be used, since the material has high resistance to an organic solvent which constitutes a solution or a dispersion of an organic light emitting material which is a component of an ink.

The affinity property of an ink affinity resin layer for an ink including an organic light emitting material can be greater than the affinity property for the ink of a convex part or convex part forming layer.

In addition, it is desirable that the contact angle θ between convex part 1A and an ink including an organic light emitting material is 10° larger than the contact angle θ between convex part 1B and an ink including an organic light emitting material. In the case where the difference in the contact angle θ is less than 10°, it is difficult for convex part 1A to have sufficient ink repellent property for an ink and to prevent an ink from flowing in a concave part.

As an ink, a material including an organic light emitting material, a solvent whose boiling point is equal to or more than 70° or less than 180° and a solvent whose boiling point is equal to or more than 180° and equal to or less than 270° can be used. In this case, it is desirable that the weight ratio of a solvent whose boiling point is equal to or more than 180° and equal to or less than 270° to an ink should be equal to or more than 5 wt % and equal to or less than 30 wt %.

Examples of solvents whose boiling points are equal to or more than 180° and equal to or less than 270° are one or more kinds of solvents selected from 2,3-dimethylanisole, 2,5-dimethylanisole, 2,6-dimethylanisole, trimethyl anisole, tetralin, methyl benzoate, ethyl benzoate, cyclohexylbenzene, n-amyl benzene, tert-amyl benzene and diphenyl ether dimethyl sulfoxide.

As light emitting materials, those obtainable by dissolving a low molecular fluorescent dye into a polymer such as polystyrene, polymethylmethacrylate, polyvinylcarbazole and polymer light emitters such as a polyphenylenevinylene (PPV) derivative and a polyalkylfluorene (PAF) derivative are usable. Since it is possible to form a film from these high molecular light emitting materials (high molecular light emitting materials for EL elements) by a coating process or a printing process by dissolving the high polymer material into a solvent to make an ink, the high molecular light emitting materials have advantages of enabling film formation in the atmosphere and low installation cost as compared to the organic EL element using the low molecular materials.

Hereinafter, an example of a method for manufacturing a relief printing plate S is described below.

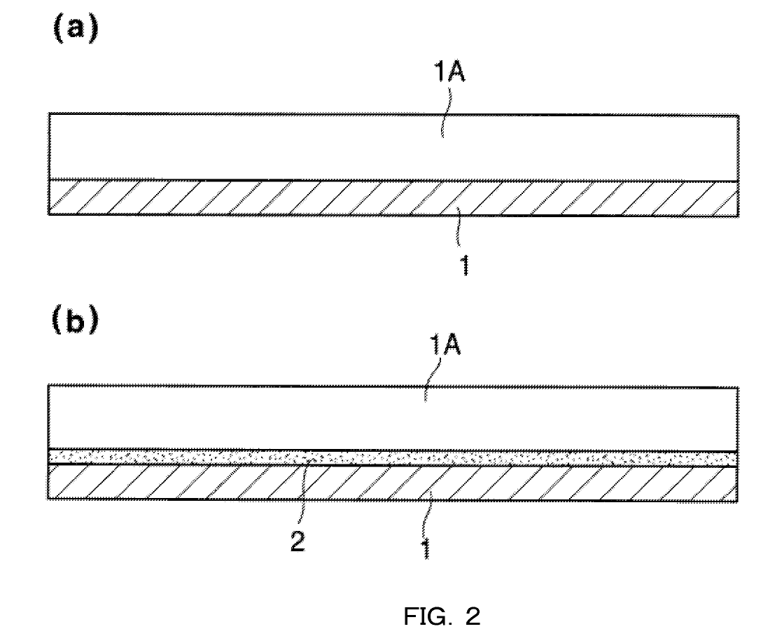

First of all, as shown in the transverse cross-sectional view of FIG. 2, a forming layer of convex part 1A is laminated and bonded to the base material 1. The base material 1 can use one or more of the following materials as a main component: a known synthetic resin such as polyethylene, polystyrene, polybutadiene, polyvinyl chloride, polyvinylidene chloride, polyvinyl acetate, polyamide, polyethersulfone, polyethylenetelephthalate, polyethylenenaphthalate, polyethersulfone, and polyvinyl alcohol; metal such as iron or copper. A forming layer of convex part 1A can be manufactured on base material 1 by the extrusion molding method, press molding method or lamination method. In addition, coating methods such as spin coat method, die coat method, slit coat method, cast coat method and dip coat method can be used.

In addition, as shown in FIG. 2 (b), in order to improve the adhesive property between base material 1 and convex part 1A, base material 1 can be attached to convex part 1A by using an adhesive 2 or a surface preparation agent between base material 1 and convex part 1A.

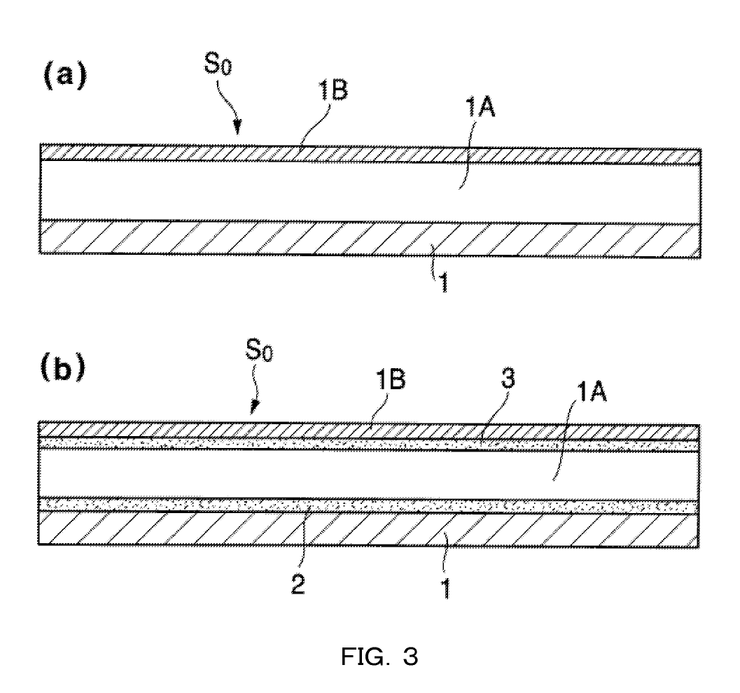

Next, as shown in FIG. 3 (a), after a layer for convex part 1A is formed on base material 1, a layer for top surface 1B is formed on the layer for convex part 1A. A layer for top surface 1B can be manufactured by the extrusion molding method or press molding method. In addition, coating methods such as the spin coat method, die coat method, slit coat method, cast coat method or dip coat method can be used.

In addition, as shown in FIG. 3 (b), in order to improve the adhesive property between base material 1 and convex part 1A, base material 1 can be attached to convex part 1A using adhesive 2 or a surface preparation agent between base material 1 and convex part 1A. In order to improve an adhesive property between a layer for convex part 1A and a layer for top surface 1B, a layer for convex part 1A can be attached to a layer for top surface 1B by using adhesive 3 or a surface preparation agent between a layer for convex part 1A and a layer for top surface 1B.

From a side of a front surface of top surface 1B of a plate-like laminate material S0, shown in FIG. 3(a), obtained by the above-mentioned process, a forming layer for top surface 1B and a forming layer for convex part 1A are chipped off using a metal knife or by a laser ablation method, thereby the relief printing plate S of the present invention can be manufactured by forming convex part 1A with top surface 1B shown in FIG. 1. In addition, in the case where a photosensitive resin is used as a resin for a forming layer for convex part 1A, relief printing plate S of the present invention can be manufactured by forming convex part 1A with top surface 1B shown in FIG. 1 by well-known methods such as pattern exposure and development.

In addition, from a side of a front surface of top surface 1B of plate-like laminate material S0, shown in FIG. 3(b), obtained by the above-mentioned process, a forming layer for top surface 1B and a forming layer for convex part 1A are chipped off by using a metal knife or by the laser ablation method, thereby relief printing plate S of the present invention can be manufactured by forming convex part 1A with top surface 1B shown in FIG. 1. In addition, in a case where a photosensitive resin is used as a resin for a forming layer for convex part 1A, relief printing plate S of the present invention can be manufactured by forming convex part 1A with top surface 1B shown in FIG. 1 by well-known methods such as pattern exposure and development.

Further, an example of a method of manufacturing a printing plate which is different from the above-mentioned method is described below.

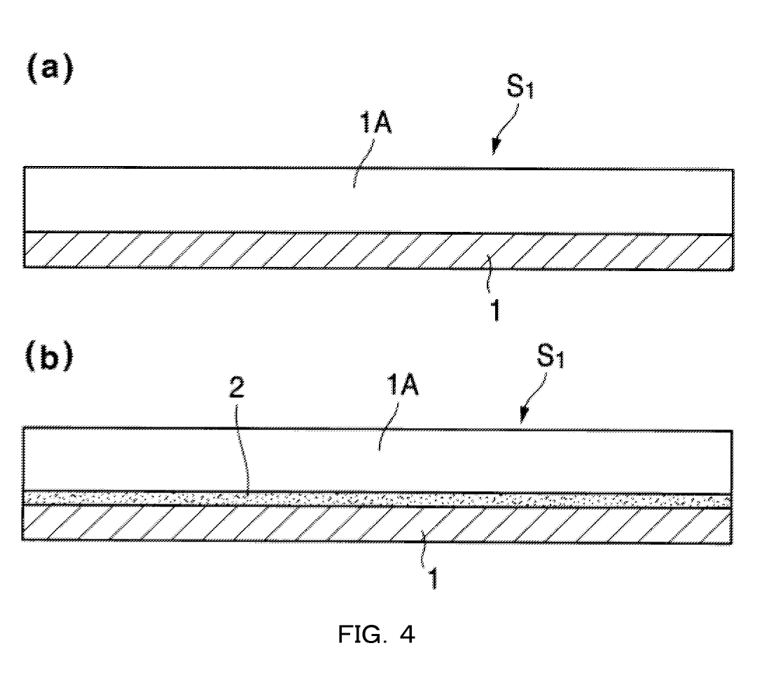

First of all, as shown in FIG. 4 (a), a layer for top surface 1B is formed on base material 1, thereby laminated body S is manufactured. In this case, examples of main components of base material 1 include well-known synthetic resins such as polyethylen, polystyrene, polybutadiene, polyvinyl chloride, polyvinylidene chloride, polyvinyl acetate, polyamide, polyethersulfone, polyethylene terephthalate, polyethylenenaphthalate, polyethersulfone and polyvinyl alcohol, and metals such as iron and copper. Convex part 1A can be manufactured by supplying a forming material to be convex part 1A on base material 1 by the extrusion molding method, press molding method or lamination method. In addition, a coating method such as the spin coat method, die coat method, slit coat method, cast coat method or dip coat method can be used. In addition, as shown FIG. 4 (b), in order to improve the adhesive property between base material 1 and convex part 1A, adhesive 2 or a surface preparation agent is provided between the members.

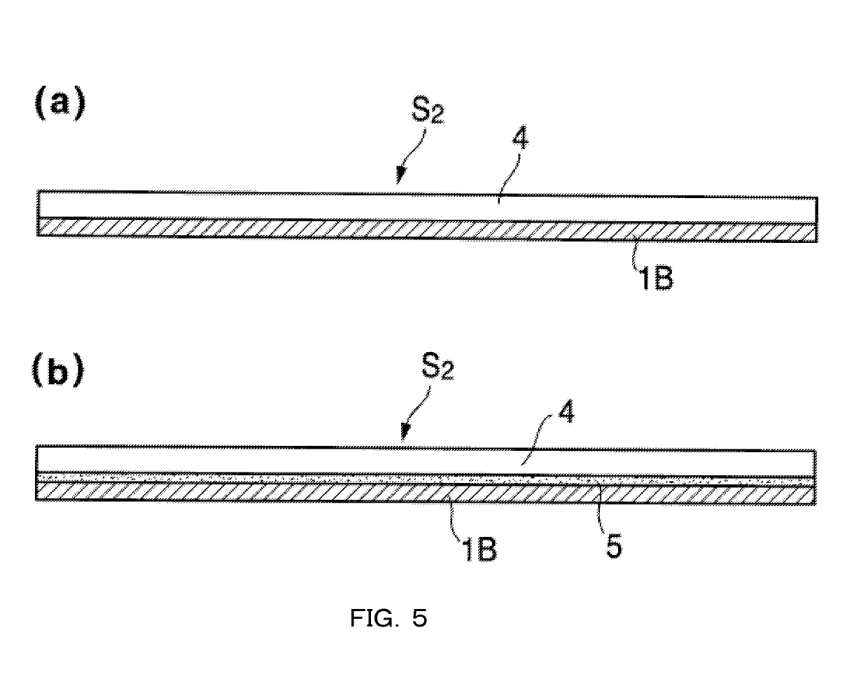

Next, as shown in FIG. 5 (a), a layer for top surface 1B is formed on protective base material 4 which is different from the above-mentioned base material 1, thereby laminated body 2 is manufactured. In this case, protective base material 4 is made from a material having an easily peeling property for a forming material for a layer for top surface 1B. In this case, examples of materials of protective base material 4 include well-known synthetic resins such as polyethylen, polystyrene, polybutadiene, polyvinyl chloride, polyvinylidene chloride, polyvinyl acetate, polyamide, polyethersulfone, polyethylene terephthalate, polyethylenenaphthalate, polyethersulfone and polyvinyl alcohol. Further, examples of materials of protective base material 4 include thin plate materials, main component of which are metals such as iron and copper which have an easily peeling property for a forming material for a layer for top surface 1B.

In addition, in FIG. 5 (a), top surface 1B is laminated and bonded to protective base material 4 by the extrusion molding method, press molding method or lamination method. In addition, a coating method such as the spin coat method, die coat method, slit coat method, cast coat method or dip coat method can be used. In addition, as shown in FIG. 5 (b), base material 4 can be laminated and bonded to top surface 1B by using an easily peeling agent 5 there between in order to achieve a temporally bonding property and easily peeling property between base material 4 and top surface 1B.

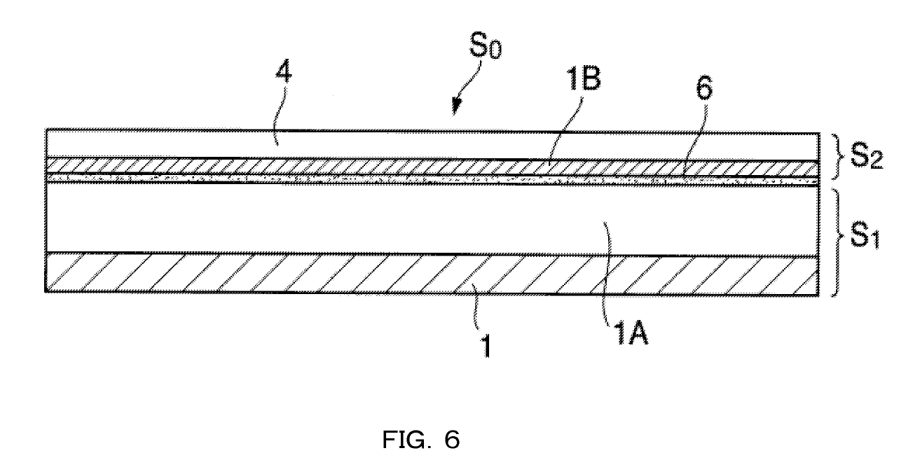

Next, as shown in FIG. 6, a forming layer for top surface 1B of laminated body S2 shown in FIG. 5 (a) or FIG. 5 (b) is put on a forming layer for convex part 1A of laminated body S1 shown in FIG. 4 (a) or FIG. 4 (b). Thereafter laminate material S0 is formed by pressing and/or bonding using a lamination method or press molding method. In addition, laminated body S1 and laminated body S2 are laminated and bonded to each other while adhesive or a surface preparation agent is provided at an adhesive interface between laminated body S1 and laminated body S2, in order to improve the adhesive property.

Protective base material 4 is peeled and removed from plate-like laminate S0 shown in FIG. 6 obtained by the above-mentioned method. Thereafter a forming layer for top surface 1B and a forming layer for convex part 1A are chipped off using a metal chipping knife or by a laser ablation method, the chipping being performed from a front surface side of top surface 1B of laminate material S0, thereby convex part 1A with top surface 1B shown in FIG. 1 is formed to manufacture a relief printing plate S of the present invention. In addition, in the case where a photosensitive resin is used as a resin for a forming layer for convex part 1A, relief printing plate S of the present invention can be manufactured by forming convex part 1A with top surface 1B shown in FIG. 1 using well-known methods such as pattern exposure and development.

A printing machine equipped with relief printing plate S can be used for printing in a relief printing method. For example, relief printing plate S can be equipped with a cylindrically pressing type relief printing machine or a cylindrically pressing type relief offset printing machine to perform the printing.

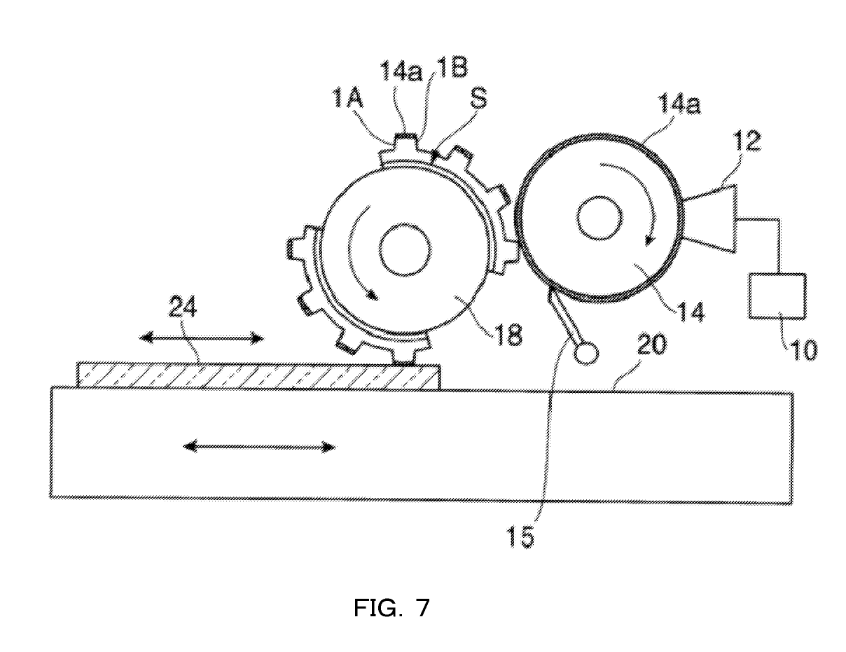

For example, a cylindrically pressing type relief printing machine is shown in FIG. 7. As shown in the figure, the machine has ink tank 10, ink ejecting part 12 (chamber) which supplies an ink, anilox roll 12 which rotates in a direction shown by an arrow. The anilox roll 12 includes a hard type roll made of a metal or a resin, or a soft type elastic roll, and plate cylinder 18 which rotates in a direction shown by an arrow. The plate cylinder is capable of having a relief printing plate S thereon. There is surface table 20, under the plate cylinder 18, for fixing a substrate to be printed, which substrate is reciprocating in a direction shown by an arrow (in a horizontal direction).

An ink is taken to ink tank 10. An ink in the ink tank 10 is sent to ink ejecting part 12. Anilox roll 14 touches ink ejecting part 12 and rotates while touching relief printing plate S on plate cylinder 18.

According to the rotation of anilox roll 14, ink 14a ejected on a surface of anilox roll 14 from ink ejecting part 12 becomes even in film thickness by scraping by doctor 15. Thereafter ink 14a with even film thickness on a surface of anilox roll 14 is transferred to top surface 1B of convex part 1A of relief printing plate S.

Further, substrate 24 (a substrate to be printed) on surface table 20 is horizontally moved in a left direction of the figure to a printing starting point, as shown in FIG. 7, while a phase position is adjusted by a position adjusting mechanism which adjusts a phase position of convex patterns comprising convex part 1A of relief printing plate S with relative to substrate 24.

Thereafter, surface table 20 is horizontally moved in the right direction of the figure in accordance with the rotation speed of plate cylinder 20 while convex part 1A of relief printing plate S on plate cylinder 18 touches substrate 24 in a state that a desired printing pressure is applied, thereby convex patterns comprising ink 14a on top surface 1B of convex part 1A of relief printing plate S are printed on a surface of substrate 24.

After printing, substrate 24 is removed from surface table 20. Thereafter next substrate 24 is fixed on surface table 20. By the repeating this process, printing is performed.

In addition, a cylindrically pressing type relief printing machine comprises a cylinder type blanket cylinder and a flat surface table which is fixed and placed at a predetermined position, both members being not illustrated in a figure. This machine has the following members in detail: a flat surface table for fixing horizontally flat relief printing plate S at a predetermined position; a flat surface table for fixing horizontally a substrate (a substrate to be printed) at a predetermined position; an ink supplying roller which puts an ink on top surface 1B by moving, rotating and touching on a surface of relief printing plate S placed and fixed on a surface table for fixing relief printing plate S; and a blanket cylinder, wherein an ink on top surface 1B is transferred to a blanket whose surface is made of rubber, by the blanket rotating and moving on a surface of relief printing plate S in a stand by mode of an ink supplying roller, and wherein an ink transferred on a surface of a blanket is transferred to a substrate (a substrate to be printed) by a blanket cylinder rotating and moving, thereby printing is performed.

A relief printing plate of the present invention has two or more layers, wherein a convex part corresponding to a printing area of a relief printing plate is formed using a material layer having affinity for an ink liquid so that an ink liquid of an organic light emitting material does not flow to a lower part or a concave part which is a surrounding area of a convex part. In addition, a part corresponding to a lower part or a concave part which is a surrounding area of a convex part, the area corresponding to a non-printing area, is formed by using a material layer having ink repellent property for an ink liquid.

In a case where printing is performed by a relief printing method or relief offset printing method using an ink liquid having low viscosity such as an organic light emitting material ink, even if an ink has low viscosity, since a lower part or a concave part corresponding a non-printing area which is not top surface of a convex part comprises a resin layer having an ink repellent property, an ink put on a top surface of a convex part having affinity for an ink by ink supplying means does not easily flow to a lower part or a convex part from a top surface because an ink is repelled by a lower part or a concave part of a resin layer having an ink repellent property.

Since a relief printing plate of the present invention comprises two or more layers, repeatability of printing an image or a pattern can be improved in relief offset printing using a low viscosity ink compared with a printing plate comprised of a single layer, thereby evenness in the film thickness of a printed ink can be improved. For example, repeatability is good in printing a film pattern by relief printing or relief offset printing using a low viscosity ink of an organic light emitting material or the like, or in printing a film pattern on a substrate such as a substrate for manufacturing a precision component or the like, thereby a printed precision component can be manufactured with a good repeatability.

### EXAMPLES

Hereinafter, examples of relief printing plate S of the present invention are described.

### <Making an Ink for Forming a Light Emitting Layer>

Ink liquid 14a for forming a light emitting layer was made by dissolving a polymer fluorescent material or a polymer fluorescent material with a polymer resin binder in xylene so that the concentration of a polymer fluorescent material was 1.0 wt %. Here, a polymer fluorescent material was a light emitting material comprising poly (para phenylenevinylene) derivative.

### <Preparing a Substrate to be Printed>

A film of 100 nm comprising poly (3,4) ethylenedioxy thiophen/polystyrene sulfonate (PEDOT/PSS) was formed as a hole transport layer using a spin coater on an ITO film surface of a substrate for manufacturing a transparent electrode (a product of GEOMATEC CO., LTD.), wherein a circuit pattern-shaped ITO film having surface resistance of 15Ω was formed on a glass substrate of 150 mm×150 mm square and 0.4 mm thickness. Further, substrate 24 was manufactured by drying this substrate with PEDOT/PSS for 1 hr. under a reduced pressure at 100° C.

<Manufacturing Relief Printing Plate S; Convex 1A Comprises a Material Including Fluorine. Top Surface 1B Comprises Water Solubility Polymer.>

As shown in FIG. 3 (a), polyethylene terephthalate (PET) of 0.3 mm thickness was used as base material 1, and a forming layer for convex part 1A of 0.1 mm thickness was formed on base material 1 by the extrusion molding method using polyvinylidene fluoride. Further, a material obtained by heating and melting water solubility polymer (water solubility resin) at 150° C. was formed as top surface 1B of 0.1 μm thickness by the spin coat method on a layer for convex part 1A, thereby laminate material S0 was manufactured.

Subsequently, the forming layers for top surface 1B and convex part 1A of laminate material S0 were chipped off by the laser ablation method, thereby concave part 1A0 which reached a layer for convex part 1A was formed in a surface of laminate material S0. Accordingly, convex part 1A with top surface 1B shown in FIG. 1 was formed, thereby relief printing plate S of the present invention was manufactured.

### <Printing an Ink Liquid for Forming an Organic Light Emitting Layer by Relief Printing Plate S>

First of all, relief printing plate S of the present invention shown in FIG. 1 was equipped with a surface of plate cylinder 18 of a cylindrically pressing type printing machine (See FIG. 7), and a substrate 24 (substrate to be printed) was placed and fixed on a surface table 20.

Next, by rotating anilox roll 14 and plate cylinder 18, an ink 14a for forming a light emitting layer was supplied on a surface of anilox roll 14 (an ink supplying roller) so that the film thickness of an ink was even. Thereafter, through anilox roll 14, ink liquid 14a was supplied on the top surface 1B of the convex part 1A of the relief printing plate S. Thereafter, a pattern-shaped ink 14a was printed by top surface 1B on a side of substrate 24 where an ITO film pattern was formed so that the printed pattern corresponded to an ITO film pattern.

After ink 14a of the printed substrate 24 was dried for 5 hrs. at 150° C., Ca of 1 nm and Al of 80 nm were formed on a light emitting layer comprised of ink liquid 14a, thereby an organic light emitting element which was a light emitting layer substrate for a cathode was manufactured.

### Reference Example 1

### A Case where a Water Solubility Polymer was not used for Top Surface 1B

By the almost same method as example 1, laminate material S0 was formed to manufacture a relief printing plate. An ink liquid for forming a light emitting layer was printed using the relief printing plate, thereby an organic light emitting element which was a light emitting layer substrate for a cathode was manufactured. However, a water solubility polymer was not used for top surface 1B.

### Reference Example 2

### A Case where Fluorine was not used for Convex Part 1A

By the almost same method as example 1, laminate material S0 was formed to manufacture a relief printing plate. An ink liquid for forming a light emitting layer was printed using the relief printing plate, thereby an organic light emitting element which was a light emitting layer substrate for a cathode was manufactured. However, fluorine was not used for convex part 1A.

### <Comparison Result>

When an electric voltage was, through an ITO film, applied to an organic light emitting element manufactured in Example 1 to observe a light emitting state, the film thickness of a light emitting layer was even and unevenness in emitting light was not observed. When an electric voltage was, through ITO film, applied to organic light emitting elements manufactured in Reference Examples 1, 2 to observe a light emitting state, unevenness in light emitting due to unevenness of film thickness was observed.

(Japanese application number 2005-281299, which was filed on Sep. 28, 2005, is incorporated herein by reference.)

What is claimed is:

1. A relief printing plate, comprising:
a resin layer having affinity for an ink; and
a convex part supporting the resin layer or a convex part forming layer including a convex part,
wherein the resin layer has affinity for an ink including an organic light emitting material; and
wherein the convex part or the convex part forming layer comprises an ink repellent layer having repellent property for the ink.

2. The relief printing plate according to claim 1,
wherein a contact angle between the ink repellent layer and the ink is 10° larger than a contact angle between the resin layer and the ink.

3. The relief printing plate according to claim 1,
wherein the resin layer comprises a resin, a main component of which is a water solubility polymer.

4. The relief printing plate according to claim 1,
wherein the ink repellent layer comprises a fluorine type material.

5. A printed matter which is obtained by pattern printing of an ink-like material on a substrate using the relief printing plate according to claim 1.
